(19) United States
(12) Patent Application Publication
(10) Pub. No.: US 2025/0279926 A1
(43) Pub. Date: Sep. 4, 2025

(54) SYSTEM FOR EFFICIENT LINK FAILURE MANAGEMENT USING PHYSICAL LAYER TRANSMISSION

(71) Applicant: MELLANOX TECHNOLOGIES, LTD., Yokneam (IL)

(72) Inventors: Gil GOLAN, Netanya (IL); Zvi RECHTMAN, Petah Tikva (IL); Ran RAVID, Tel Aviv (IL); Guy LEDERMAN, Ness Ziona (IL); Asaf HOREV, Tel Aviv (IL); Oded NADIR, Ramat HaShofet (IL); Lavi KOCH, Tel Aviv (IL); Andy RODAN, Kiryat Haim (IL)

(73) Assignee: MELLANOX TECHNOLOGIES, LTD., Yokneam (IL)

(21) Appl. No.: 18/594,729

(22) Filed: Mar. 4, 2024

(51) Int. Cl. H04L 41/0654; H04L 43/0823

(52) U.S. Cl. CPC H04L 41/0654; H04L 43/0823

(57) ABSTRACT

Systems, computer program products, and methods are described for efficient link-down management. An example transmitter detects an impending link-down event at the transmitter. Once detected, the transmitter encodes the link-down event within a control block. The encoded control block is then transmitted via a physical layer of the communication network to a receiver. Once the control block is transmitted, the transmitter then initiates the link-down event. An example receiver receives the control block via a physical layer of the communication network from a transmitter. Then, the receiver extracts, from the control block, an operational code (opcode) identifying an impending link-down event at the transmitter. In response, the receiver retrieves, from a database, a responsive action corresponding to the link-down event based on the extracted opcode and subsequently executes the responsive action.

### TECHNOLOGICAL FIELD

Example embodiments of the present invention relate to link-down event management.

### BACKGROUND

Port management directly impacts the maintenance and performance of network devices. The complexity of port management becomes particularly evident when addressing issues related to link drops, a common challenge in data center operations. Troubleshooting link-down issues typically involves extracting and analyzing data logs from both sides of the link. However, challenges arise when the data needed for a thorough analysis is either unavailable or inaccessible.

Applicant has identified a number of deficiencies and problems associated with link-down event management. Many of these identified problems have been solved by developing solutions that are included in embodiments of the present disclosure, many examples of which are described in detail herein.

### BRIEF SUMMARY

Systems and methods are therefore provided for efficient link-down event management using physical layer encoding.

In one aspect, a transmitter configured to transmit a control block over a communication network is presented. The transmitter comprising: a processor; and a non-transitory storage device containing instructions that, when executed by the processor, cause the processor to: detect an impending link-down event at the transmitter; encode the link-down event within a control block; transmit the control block via a physical layer of the communication network to a receiver; and initiate the link-down event at the transmitter.

In some embodiments, encoding the link-down event within the control block further comprises: generating an operational code (opcode) identifying the link-down event, wherein the opcode, when decoded at the receiver, triggers a responsive action at the receiver corresponding to the link-down event.

In some embodiments, the instructions, when executed, cause the processor to: transmit the control block with the link-down event encoded therewithin to the receiver for a predefined duration after the detection of the impending link-down event at the transmitter; and initiate the link-down event subsequent to a lapse of the predefined duration.

In some embodiments, the instructions, when executed, cause the processor to: transmit a predefined number of control blocks with the link-down event encoded therewithin to the receiver after the detection of the impending link-down event at the transmitter; and initiate the link-down event subsequent to transmitting the predefined number of control blocks.

In some embodiments, the communication network is a high-performance computing network, and wherein the control block is a training sequence 1 (TS1) control block.

In some embodiments, encoding the link-down event within the control block further comprises encoding the link-down event within a designated byte of the TS1 control block, wherein the designated byte is byte 7 of the TS1 control block.

In some embodiments, the communication network is local area network (LAN), wherein the control block is associated with a binary block coding, and wherein the control block is a faults control block.

In some embodiments, the link-down event comprises at least one of a thermal event, a device reset, a forced device shutdown, a local command to sleep, a local command to disable, or a locked port.

In one aspect, a receiver configured to receive a control block over a communication network is presented. The receiver comprising: a processor; and a non-transitory storage device containing instructions that, when executed by the processor, cause the processor to: receive the control block via a physical layer of the communication network from a transmitter; extract, from the control block, an operational code (opcode) identifying an impending link-down event at the transmitter; retrieve, from a database, a responsive action corresponding to the link-down event based on the extracted opcode; and execute the responsive action.

In some embodiments, the instructions, when executed, cause the processor to: transmit an acknowledgement of the impending link-down event to the transmitter in response to decoding the control block.

In some embodiments, the responsive action comprises at least temporarily pausing communication between the transmitter and the receiver.

In some embodiments, executing the responsive action corresponding to the link-down event changes a state of the receiver.

In another aspect, a method for transmitting a control block over a communication network is presented. The method comprising: detecting an impending link-down event at a transmitter; encoding the link-down event within a control block control block; transmitting the control block via a physical layer of the communication network to a receiver; and initiating the link-down event at the transmitter.

In yet another aspect, a method for receiving a control block over a communication network is presented. The method comprising: receiving the control block via a physical layer of the communication network from a transmitter; extracting, from the control block, an operational code (opcode) identifying an impending link-down event at the transmitter; retrieving, from a database, a responsive action corresponding to the link-down event based on the extracted opcode; and executing the responsive action.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrate an example network environment for link-down event management, in accordance with an embodiment of the present invention;

FIG. 2 illustrates an example device circuitry for link-down event management, in accordance with an embodiment of the present invention;

FIG. 3 illustrates a method for encoding a link-down event communication via physical layer encoding, in accordance with an embodiment of the invention;

FIG. 4 illustrates a method for executing a responsive action in response to a link-down event, in accordance with an embodiment of the invention; and

FIG. 5 illustrates an example implementation of link-down event management using physical layer encoding, in accordance with an embodiment of the invention.

### DETAILED DESCRIPTION

### Overview

Efficient port management is important to reducing power consumption, especially with the growing number of networking ports in data centers due to the expansion of AI and cloud systems. This increase complicates the implementation of a uniform port management strategy across different systems. For instance, during a device's maintenance shutdown, port management strategies must adapt to the specific application. In cases where a continuous connection is essential, such as when an optical laser is in a polling stage, ports may remain active to re-establish connections. On the other hand, in scenarios where immediate reconnection is not critical, ports may enter a sleep state to conserve energy, turning off non-essential functions and thus reducing power consumption.

Port management directly impacts the maintenance and performance of network devices. The complexity of port management becomes particularly evident when addressing issues related to link drops, a common challenge in data center operations. Troubleshooting link-down issues typically involves extracting and analyzing data logs from both sides of the link. However, challenges arise when the data needed for a thorough analysis is either unavailable or inaccessible. The troubleshooting process often entails gathering various metrics to pinpoint the causes of port failures, which may include thermal events, reset requests, or a high Bit Error Rate (BER). The critical aspect of this process is the time involved in assembling all the relevant information to diagnose the cause of the link-down and then implementing an appropriate response. Any delay in this debugging and response cycle can have a considerable impact, significantly reducing the performance and efficiency of the data center.

Embodiments of the invention introduce a method for efficient communication between interconnected network devices during critical events. This approach enables devices to rapidly share status information, such as thermal events, facilitating proactive management and response to maintain network integrity. For instance, in an example networking environment with two interconnected devices, Device A and Device B may be interconnected through Ports A and B, respectively. These devices could include switches, graphical processing units (GPUs), network interface cards (NICs), SmartNICs, or similar network-enabled hardware. When Device A experiences overheating necessitating a shutdown, it may communicate this condition to Device B via Port A. Upon receiving this information, Device B may record it in its local memory and initiate its own shutdown procedures while sending an acknowledgment back to Device A. The information may direct Device B to enter a SLEEP state, conserving power by deactivating unnecessary circuits, and remain in this state until Device A cools down and restarts its port. If Device A does not communicate the thermal event to Device B, Device B would remain unaware of Device A's thermal issue, resulting in an immediate link drop and subsequent attempts to re-establish the connection, leading to significant response delays.

For more efficient communication, embodiments of the invention utilize lower layers of the communication network (e.g., the physical layer) to communicate information on imminent link-down events. Employing the lower layers of the network significantly reduces the time it takes for Device B to receive and process the shutdown notification from Device A. This expedited communication method allows Device B to respond more efficiently. In an example embodiment in which the communication network is an InfiniBand® network, the link-down information may be integrated into the training sequence 1 (TS1) control block (as defined by the InfiniBand Trade Association (IBTA) standard). Specifically, the reason for the link-down event may be encoded as an operational code (opcode) into Byte 7 of TS1. In the context of a link on the verge of going down, the transmitter device's physical coding sublayer (PCS) encoder may dispatch the TS1 control block, which is encoded with the relevant opcode indicating the reason for the impending link-down. Simultaneously, the receiver device's PCS decoder, upon receiving a TS1 control block, may check Byte 7 for the opcode and respond by executing a pre-configured link-down action (e.g., disable (completely turn off the local port), sleep (wake up on remote request), poll (actively try to wake up a remote port), and/or the like). In cases where no specific reason is encoded, the receiver device may be configured to default to a standard link-down state.

Embodiments of the invention are particularly more advantageous in data center environments, where devices may be directly connected through DC pathways, making them more susceptible to damage from rapid voltage changes or other electrical anomalies. Traditional software-based network management solutions in such contexts tend to have response times on the order of hundreds of milliseconds. This delay can be detrimental, potentially leading to device damage in scenarios where immediate response is critical. In contrast, embodiments of the invention provide a buffer between the communication of a link-down event and its actual initiation at the transmitter. This buffer is designed to allow sufficient time for the receiver to execute a pre-determined responsive action upon receiving the communicated link-down event. By doing so, it effectively mitigates or even avoids the detrimental effects that could result from a sudden link-down event in a DC coupled environment.

Furthermore, by preconfiguring all communication port states locally within each device, embodiments of the invention eliminate the need for external software-based network management to handle these configurations. This local pre-configuration allows for immediate and autonomous adaptation of port behaviors in response to varying network conditions, particularly in critical scenarios such as link-down events. Each device, equipped with this capability, can rapidly adjust its port states, such as entering a sleep mode or disabling a port, based on the decoded information from the received opcodes. Additionally, this approach significantly streamlines the network management process. Without the dependency on centralized software solutions for port configuration, the network becomes more robust against latency and more responsive to real-time changes.

In addition, embodiments of the invention streamline the management of responses to link-down events by enabling access and diagnostics from only one side of the port. This approach represents a significant improvement over conventional troubleshooting methods, which typically require inspection and analysis of both sides of the link. Such traditional methods can be time-consuming and complex, often demanding coordinated efforts between multiple network components or devices.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “interconnected” may imply that each component is directly or indirectly linked to every other component or switch in the network, allowing for seamless data transfer and communication between all the components.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example Network Environment

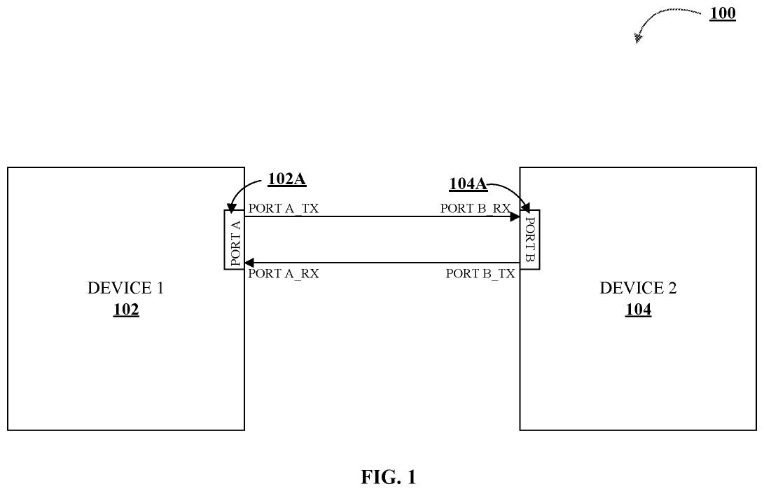

FIG. 1 illustrates an example network environment 100 for link-down event management, in accordance with an embodiment of the present invention. As shown in FIG. 1, the network environment 100 may include a first device 102 and a second device 104. FIG. 1 illustrates only one example of an embodiment of the network environment 100, and it will be appreciated that in other embodiments one or more of the systems, units, devices, and/or servers may be combined into a single system, unit, device, or server, or be made up of multiple systems, units, devices, or servers. Also, the network environment 100 may include multiple components, the same or similar to the first and second devices 102, 104, with each providing portions of the necessary operations.

The first device 102 may encompass a diverse range of electronic devices characterized by their capacity for data processing and network connectivity. As such, the first device 102 may include devices with substantial data processing capabilities such as graphical processing units (GPUs), central processing units (CPUs), and/or the like. GPUs may be specialized hardware designed for parallel processing of complex mathematical and graphical computations, making them ideal for graphics rendering, machine learning tasks, and other data-intensive operations. CPUs, on the other hand, are the central processing units responsible for handling a broad range of tasks from basic arithmetic to complex decision-making processes. The first device 102 may also include devices with substantial network capabilities such as a network interface card (NIC), a smart NIC, a switch, and/or the like. NICs, or network interface cards, may serve as the interface between a device and a network, translating data between these systems. SmartNICs may elevate this function by integrating additional processing power, enabling them to offload certain computing tasks from the CPU, thereby enhancing network performance and efficiency. Switches may be integral to network infrastructure, connecting devices within a network and facilitating the efficient routing and forwarding of data packets. Additionally, the scope of the first device 102 may extend to edge devices, exemplified by routers and routing switches used to direct data traffic, and integrated access devices (IADs), which facilitate access to various communication services. Routers may ensure that data sent over the internet arrives at the correct destination by directing traffic through the most efficient routes. Routing switches may combine the functionalities of routers and switches, offering both efficient data packet routing and local device interconnection. IADs facilitate access to various communication services, often combining the capabilities of routers, switches, and gateways in a single device. They play a pivotal role in converging data, voice, and video services, particularly in enterprise and telecommunication settings.

As shown in FIG. 1, the first device 102 may include a communication port 102A that may serve as the physical interface through which the first device 102 may connect to other devices (e.g., the second device 104) within the network environment 100. The communication port 102A may be configured for bidirectional data transmission capability, whereby the communication port 102A may facilitate both transmission and reception of data. The communication port 102A may be designed to support a wide range of networking standards and protocols, including Ethernet, InfiniBand®, and/or the like. The communication port 102A may encompass various types, including but not limited to, RJ45 connectors for Ethernet, fiber optic connectors for high-speed data transfer, wireless interfaces for Wi-Fi or Bluetooth connections, and/or the like. In addition to basic connectivity, the communication port 102A may be configured for high-speed data transmission, aligning with the substantial data processing and network capabilities of the first device 102.

The second device 104 may be the same or similar to the first device 102, encompassing the same or substantially similar structure, range of functionalities, features, and/or applications as the first device 102. Specifically, both the first device 102 and the second device 104 may share identical data processing capabilities, integrating components such as GPUs and CPUs. These elements enable each device (e.g., first device 102 and second device 104) to perform advanced computational tasks, ranging from intensive graphical processing to diverse general-purpose data management functions. In terms of network functionalities, the second device 104, similar to the first device 102, may be a NIC, SmartNIC, switch, and/or the like, allowing the second device 104 to effectively interface within a network, manage data traffic, and optimize network performance. Further, the second device 104 may be a router, routing switch, IAD, and/or the like, capable of performing tasks such as directing data traffic and facilitating access to various communication services.

As shown in FIG. 1, the second device 104, similar to the first device 102, may include a communication port 104A that serves as a physical interface for the second device 104, enabling its connection to other devices within the network environment 100, such as the first device 102. For example, the communication port 104A, similar to the communication port 102A, may be configured for bidirectional data transmission capabilities, allowing for both the transmission and reception of data. The communication port 104A may be configured to support an array of networking standards and protocols, including but not limited to Ethernet, InfiniBand®, Wi-Fi and/or the like. The communication port 104A may include multiple types of connectors, such as RJ45 connectors for Ethernet, fiber optic connectors for high-speed data transfer, wireless interfaces for Wi-Fi or Bluetooth connectivity, and/or the like. Furthermore, the communication port 104A may be configured for high-speed data transmission, complementing the substantial data processing and network capabilities inherent in the second device 104.

In some embodiments, the first device 102 and the second device 104 may communicate via a network (not shown) to facilitate efficient data exchange. For example, the communication link between the first device 102 and the second device 104 may be established using Infiniband, Ethernet®, fiber channel, NVLink®, Wi-Fi, next-generation wireless communication standards such as 5G, multi-protocol label switching (MPLS), and/or the like. The network facilitating communication between the first device 102 and the second device 104 may be characterized by a distributed network architecture. Such a distributed architecture may encompass a variety of network types, thereby establishing a comprehensive and cohesive data communication framework that allows for the network to be managed either as a unified system or as individual components, depending on the specific operational requirements. The network architecture may be designed to support both shared communication and distributed processing. The network architecture may effectively span across multiple platforms including, but not limited to, telecommunication networks, local area networks (LAN), wide area networks (WAN), global area networks (GAN), and the broader Internet infrastructure. This diversity in platforms ensures that the network can cater to a wide range of communication scenarios and data exchange requirements. Further, the network architecture may be structured to integrate and leverage emerging networking technologies, including software-defined networking (SDN) and network function virtualization (NFV), and next-generation wireless communication standards like 5G. The network may employ secure or unsecure, as well as wireless, wired, and optical interconnection technologies, and/or the like, to accommodate a wide spectrum of communication and processing needs.

It is to be understood that the structure of the network environment 100 and its components, connections and relationships, and their functions, are meant to be exemplary only, and are not meant to limit implementations of the disclosures described and/or claimed in this document. In one example, the network environment 100 may include more, fewer, or different components. In another example, some or all of the portions of the network environment 100 may be combined into a single portion or all of the portions of the network environment 100 may be separated into two or more distinct portions.

### Example Device Circuitry

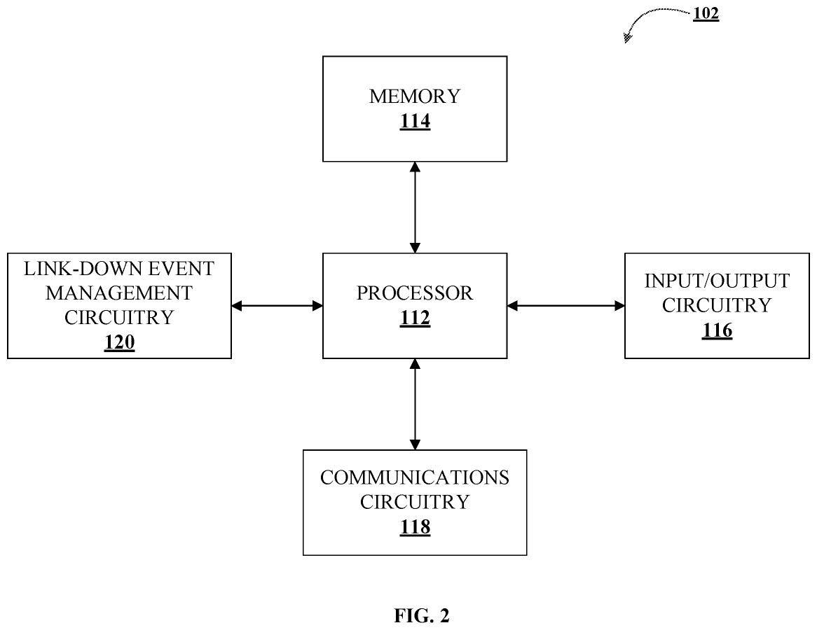

FIG. 2 illustrates an example device circuitry 102 for link-down event management, in accordance with an embodiment of the present invention. As described herein, the first device 102 and the second device 104 may embody the same or substantially similar structural configurations. Therefore, while the ensuing description focuses on the device circuitry of the first device 102, it is to be understood that the second device 104 may possess an analogous or essentially equivalent device circuitry. This parallelism in structure and function between the two devices implies that descriptions, illustrations, and technical details pertaining to the device circuitry of the first device 102 are equally applicable and representative of the second device 104, unless otherwise specified.

As shown in FIG. 2, the first device 102 may include a processor 112, a memory 114, input/output circuitry 116, communications circuitry 118, and link-down event management circuitry 120.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the first device 102 may be housed together, while other components are housed separately (e.g., a controller in communication with the first device 102). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the first device 102 may provide or supplement the functionality of particular circuitry. For example, the processor 112 may provide processing functionality, the memory 114 may provide storage functionality, the communications circuitry 118 may provide network interface functionality, and the like.

In some embodiments, the processor 112 (and/or co-processor or any other processing circuitry assisting or otherwise associated with the processor) may be in communication with the memory 114 via a bus for passing information among components of, for example, the first device 102. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the first device 102, to carry out various functions in accordance with example embodiments of the present disclosure.

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the first device 102 to carry out various functions in accordance with example embodiments discussed herein. For example, in at least some embodiments, the memory 114 may be configured to buffer data for processing by the processor 112. Additionally, or alternatively, in at least some embodiments, the memory 114 may be configured to store program instructions for execution by the processor 112. The memory 114 may store information in the form of static and/or dynamic information. This stored information may be stored and/or used by the first device 102 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 112 may include a plurality of processors. The plurality of processors may be embodied on a single computing device or may be distributed across a plurality of such devices collectively configured to function as the first device 102. The plurality of processors may be in operative communication with each other and may be collectively configured to perform one or more functionalities of the first device 102 as described herein.

In an example embodiment, the processor 112 may be configured to execute instructions stored in the memory 114 or otherwise accessible to the processor 112. Alternatively, or additionally, the processor 112 may be configured to execute hard-coded functionality. As such, whether configured by hardware or software methods, or by a combination thereof, the processor 112 may represent an entity (e.g., physically embodied in circuitry) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the first device 102 to perform one or more of the functionalities thereof as described herein.

In some embodiments, the first device 102 may further include input/output circuitry 116 that may, in turn, be in communication with the processor 112 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like.

The processor 112 and/or user interface circuitry comprising the processor 112 may be configured to control one or more functions of a display or one or more user interface elements through computer-program instructions (e.g., software and/or firmware) stored on a memory accessible to the processor 112 (e.g., the memory 114, and/or the like). In some embodiments, aspects of input/output circuitry 116 may be reduced as compared to embodiments where the first device 102 may be implemented as an end-user machine or other type of device designed for complex user interactions. In some embodiments (like other components discussed herein), the input/output circuitry 116 may be eliminated from the first device 102. The input/output circuitry 116 may be in communication with memory 114, communications circuitry 118, and/or any other component(s), such as via a bus. Although more than one input/output circuitry and/or other component can be included in the first device 102, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more communication ports (e.g., communication port 102A as shown in FIG. 1), network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna(s) to cause transmission of signals via the antenna (e) or to handle receipt of signals received via the antenna(e). These signals may be transmitted by the first device 102 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of the first device 102, such as via a bus. The communication circuitry 118 of the first device 102 may also be configured to receive and transmit information to and from the various components associated therewith.

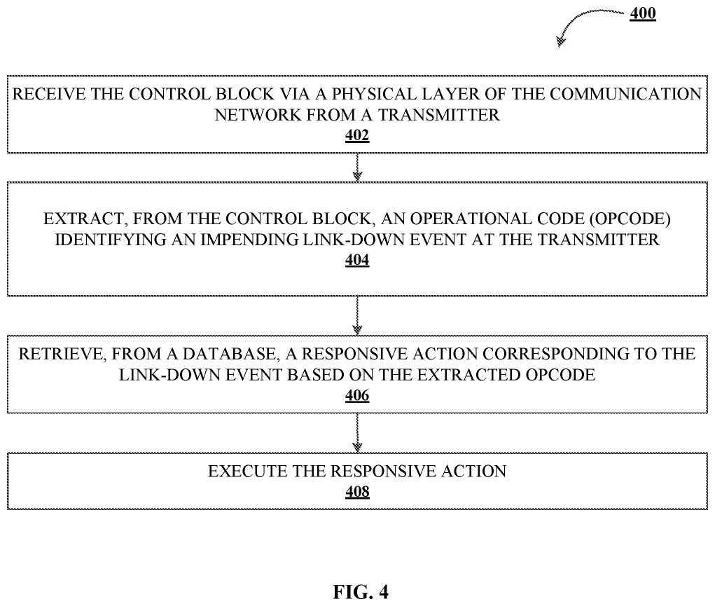

In some embodiments, the link-down event management circuitry 120 may be configured to operate effectively in both transmitter and receiver configurations. In a transmitter configuration, such as within the first device 102 (as shown and described in more detail in connection with FIG. 4), the link-down event management circuitry 120 may be configured to detect, encode, and manage link-down events. This detection may be based on predefined criteria, such as thermal thresholds or other operational anomalies, indicating a potential disruption in the first device's 102 normal functioning. Upon detection of such an event, the link-down event management circuitry 120 may encode the link-down event within a control block. A control block may be a data structure used in network communication to manage various aspects of network communication, such as connection establishment, data transfer, and connection termination. Subsequent to the encoding process, the link-down event management circuitry 120 may transmit control signals instructing the processor 112 to transmit the encoded control block via the physical layer of the communication network to a connected device. This transmission ensures that the receiving device is promptly informed about the impending link-down event, allowing it to take appropriate preemptive actions. Finally, the link-down event management circuitry 120 may transmit additional control signals instructing the processor 112 to initiate the actual link-down event at the first device 102.

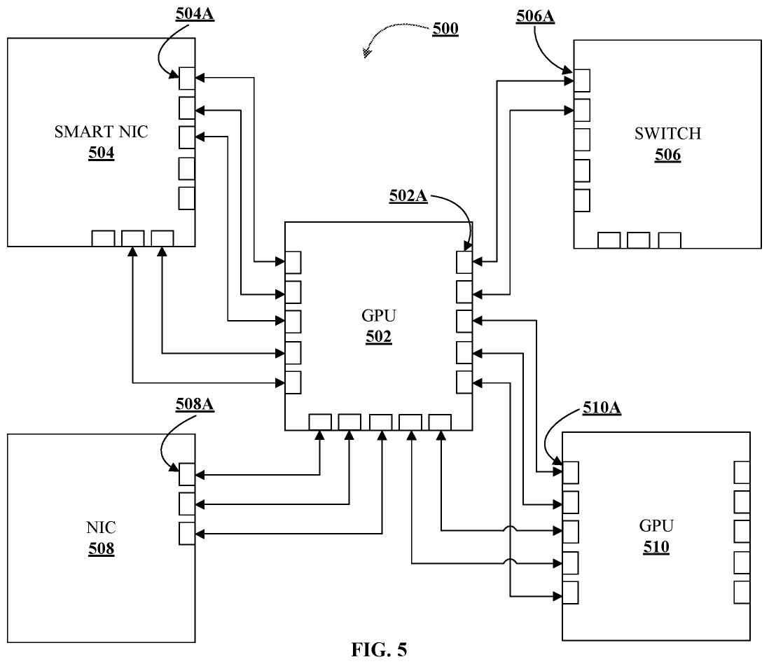

On the other hand, in a receiver configuration, such as within the second device 104 (as shown and described in more detail in connection with FIG. 5), the link-down event management circuitry 120 may be configured to respond to link-down events communicated from another device (e.g., the first device 102). In this regard, the link-down event management circuitry 120, upon receiving a control block, may extract the operational code (opcode) embedded within the control block, identifying the impending link-down event at the transmitting device. Upon identifying the link-down event, the link-down event management circuitry 120 may identify a corresponding responsive action for execution, and subsequently transmit control signals instructing the processor 112 to execute the responsive action. Thus, the link-down event management circuitry 120 may be configured to handle the specific requirements of a link-down event whether the device is the source of the event or is responding to an event occurring at another location in the network.

In some embodiments, the first device 102 may include hardware, software, firmware, and/or a combination of such components, configured to support various aspects of link-down event management as described herein. It should be appreciated that in some embodiments, the link-down event management circuitry 120 may perform one or more of such example actions in combination with another circuitry of the first device 102, such as the memory 114, processor 112, input/output circuitry 116, and/or communications circuitry 118. For example, in some embodiments, the link-down event management circuitry 120 may utilize the processing circuitry, such as the processor 112 and/or the like, to form a self-contained subsystem to perform one or more of its corresponding operations. In a further example, and in some embodiments, some or all of the functionality of the link-down event management circuitry 120 may be performed by the processor 112. In this regard, some or all of the example processes and algorithms discussed herein can be performed by at least one processor 112 and/or the link-down event management circuitry 120. It should also be appreciated that, in some embodiments, the link-down event management circuitry 120 may include a separate processor, specially configured field programmable gate array (FPGA), or application specific interface circuit (ASIC) to perform its corresponding functions.

Additionally, or alternatively, in some embodiments, the link-down event management circuitry 120 may use the memory 114 to store collected information. For example, in some implementations, the link-down event management circuitry 120 may include hardware, software, firmware, and/or a combination thereof, that interacts with the memory 114 to send, retrieve, update, and/or store data.

Accordingly, non-transitory computer readable storage media, which may, for example, be the memory 114, can be configured to store firmware, one or more application programs, and/or other software, which include instructions and/or other computer-readable program code portions that can be executed to direct operation of the first device 102 to implement various operations, including the examples described herein. As such, a series of computer-readable program code portions may be embodied in one or more computer-program products and can be used, with a device, first device 102, database, and/or other programmable apparatus, to produce the machine-implemented processes discussed herein. It is also noted that all or some of the information discussed herein can be based on data that is received, generated and/or maintained by one or more components of the first device 102. In some embodiments, one or more external systems (such as a remote cloud computing and/or data storage system) may also be leveraged to provide at least some of the functionality discussed herein.

It should be recognized that the structure of the first device 102, as detailed herein, represents merely one embodiment among a multitude of potential configurations. This particular structure of the first device 102 is delineated to demonstrate a specific arrangement and interaction of its components—encompassing data processing units, network interfaces, and link-down event management circuitry—that collectively contribute to its comprehensive network capabilities. However, this outlined configuration is not definitive or limiting. The structure of the first device 102 and its integral components can be varied to adapt to different networking paradigms, technological evolutions, and specific application needs. Alternative embodiments of the first device 102 might employ varying types of processors, such as advanced multi-core CPUs or specialized GPUs, distinct networking interfaces like SmartNICs or advanced wireless modules, and diverse methods for managing network events and communications. Moreover, the scalability, data handling techniques, and network integration approaches of the first device 102 can substantially differ based on targeted operational environments and functional requisites. Thus, while the present disclosure depicts one potential structure for the first device 102, it is to be understood that this represents just one exemplification within the broader realm of network-enabled devices. The scope of the invention is, therefore, not confined to this singular form but is extendable to various other forms, technologies, and configurations.

### Example Method for Transmitting a Control Block Over a Communication Network

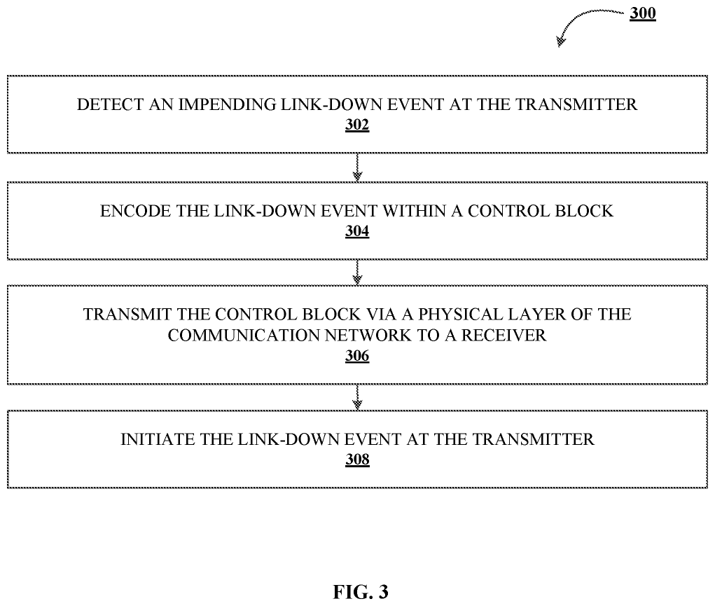

FIG. 3 illustrates an example method 300 for transmitting a control block over a communication network, in accordance with an embodiment of the invention. As shown in block 302, the method may detect an impending link-down event at the transmitter (e.g., the first device 102 as shown in FIG. 1). An impending link-down event may be detected at the transmitter by monitoring various metrics associated with the transmitter such as operational parameters, network traffic, hardware diagnostics, software and firmware health, predictive analytics, security monitoring, compliance and network policies, and/or the like. For example, the operational parameters may include temperature, power supply stability, resource utilization, and/or the like; network traffic analysis may include analysis of network traffic and volume patterns, error rates and signal quality, packet loss and latency, and/or the like; hardware diagnostics may include integrity of physical connections; software and firmware health may include system logs and alerts analysis, firmware version updates, and/or the like; predictive analytics may include historical data analysis to identify patterns or trends that might predict a future link-down event; security monitoring may include intrusion detection and prevention; and compliance and network policies may include policy adherence checks.

The link-down event may include a thermal event, a device reset, a forced device shutdown, a local command to sleep, a local command to disable, a locked port, a power supply interruption, a network congestion, firmware or software failure, security protocol triggers, resource exhaustion, maintenance operations, and/or the like. For example, a transmitter may overheat due to continuous heavy usage, triggering internal protocols to shut down to prevent hardware damage; a transmitter may automatically trigger a reset in response to a firmware issue; a transmitter may encounter a critical hardware failure and prompt an immediate and forced shutdown to prevent further damage; a transmitter may receive a command from a network management system to enter a sleep mode to conserve energy due to low network activity; a transmitter may receive a local command from an administrator to disable a specific communication port to run diagnostics; a transmitter's port may be automatically locked due to security protocols, perhaps triggered by repeated failed access attempts, indicating a potential security breach; a transmitter may experience a sudden loss of power due to an external power failure, leading to an immediate link-down; a transmitter may face network congestion, causing it to throttle or temporarily shut down connections to mitigate traffic overload; a transmitter's security unit may detect a potential threat, such as a malware infection, triggering a shutdown of its network interface as a protective measure; and/or a transmitter may run out of CPU or memory resources under heavy computational load, leading to a degradation or halt in network communication.

As shown in block 304, the method may encode the link-down event within a control block. Each link-down event may be identified by generating a corresponding operational code (opcode). An opcode may function as a unique identifier, specifically designating the nature of a link-down event. Each opcode may correspond to a specific event or state, such as a device entering a sleep mode, a port being disabled, or a thermal event occurring. For example, an opcode like “TS1.Sleep=0×1” may indicate that the transmitter is transitioning to a sleep state, while “TS1.Thermal=0×B” may signify a thermal event affecting the transmitter. These hexadecimal values may be defined within the network's communication protocol to ensure precise and consistent interpretation across all devices in the network. It is to be understood that the set of opcodes used in any given example, such as the ones provided, are illustrative and not exhaustive. Different systems or protocols may employ various other opcodes to represent a wide range of events or states, such as power failures, maintenance modes, or signal degradation. This flexibility in defining opcodes allows for tailored communication strategies within diverse network environments, enhancing the network's ability to self-monitor, diagnose issues, and maintain operational efficiency. By using these unique identifiers, transmitters can effectively communicate their status, facilitating a more responsive and resilient network infrastructure.

The opcode may be embedded within the control block, enabling a receiving device (e.g., the second device 104 as shown in FIG. 1) to recognize and respond to different types of link-down events. A control block may be a data structure used by the networking software (typically within the operating system kernel) to store information about network connections and data transmission states. In some embodiments, the control block may be embedded within a data packet, allowing direct association of control information with the data being transmitted. Alternatively, the control block may be appended to the data packet, serving as a separate segment that precedes and/or follows the data. In some instances, the control block may operate independently from the data packet, existing as a distinct entity that is neither embedded in nor appended to the data packet. Furthermore, when encoding a link-down event, the method may leverage aggregated control blocks, combining multiple control blocks to represent and communicate the occurrence of link-down events efficiently. The structure of the control block may vary depending on the type of communication network being used, as different network protocols and standards have their own specific requirements and designs for packet structure.

In a high-performance computing network such as Infiniband®, the opcode may be embedded within a training sequence control block (e.g., TS1 control block). The TS1 control block may be used to establish and stabilize the physical layer link between communication ports. TS1 control block may contain information such as synchronization patterns and may also include configuration details for the link, such as the desired data rate and other operational parameters. In some example embodiments, the TS1 control block, as defined by the Infiniband Trade Association (IBTA) standard, may have a size of 8 bytes. Here, byte 0 may include a specific pattern or value used for synchronization or identification purposes, byte 1-3 may represent a continuation of the synchronization pattern or other control information necessary for the training sequence, and bytes 4-7 may be reserved for specific purposes. In specific embodiments, the opcode may be encoded within a reserved Byte 7 of the TS1 control block.

In an Ethernet-based communication network, similar to the InfiniBand® approach, the opcode may be encoded within the Faults control block—a designated part of the Ethernet framework that uses binary block coding to process signaling errors or faults within the network. Similar to encoding the opcode in byte 7 of the TS1 block in Infiniband®, the opcode may be encoded within a reserved byte of the Faults control block in the Ethernet-based communication network. Alternatively or additionally, the opcode may be encoded within other available control blocks that use binary block coding in the Ethernet-based communication network.

As shown in block 306, the method may transmit the control block via a physical layer of the communication network to a receiver. The physical layer of a communication network may be responsible for the transmission and reception of raw data streams over a physical medium. In particular, the physical layer may deal with electrical, mechanical, and procedural interfaces to the physical medium and may transfer data across that medium. To transmit the control block via the physical layer, the control block, which contains digital data, may be encoded into signals suitable for transfer over the physical medium using a physical coding sublayer (PCS) associated with the physical layer of the communication network. PCS may be configured to translate raw binary data from higher network layers into signal forms that can be reliably and efficiently transmitted through various mediums, such as copper wires, optical fibers, or wireless channels.

For example, the physical layer in communication networks such as NVLink®, Infiniband®, Ethernet, and/or the like may use a coding scheme called 64/66b to convert 64 bits of raw data into 66 bits of encoded data, with the extra two bits providing a mechanism for various control functions. The 64/66b encoding may allow for data integrity and error detection, clock synchronization, control and data differentiation, and/or the like. In NVLink® networks, for example, the 64/66b encoding may be used to ensure high data integrity and efficient utilization of the link. The additional bits can be used for flow control and to manage the direct GPU-to-GPU or GPU-to-CPU communications. In Ethernet, for example, the 64/66b encoding scheme may be used to ensure that the data stream remains synchronized and that the receiving end can clearly identify the beginning and end of frames. In Infiniband®, for example, the 64/66b encoding may be used to ensure that the control information necessary for managing the InfiniBand® fabric is effectively communicated. In specific embodiments, the 64/66b coding scheme may be used to encapsulate the control block within which the opcode is encoded.

As described herein, upon detection of an impending link-down event, the transmitter may embed the specific opcode within the control block. This control block acts as an alert mechanism, signaling to the receiver that a link-down event is anticipated. This encoding may be a continuous process that may persist for a predefined duration. The predefined duration may be established based on factors such as the criticality of the impending link-down event and the network's ability to handle link transitions. During this predefined duration, the transmitter may continue normal operations while also preparing for the impending link-down event. Alternatively or additionally, the opcode may be encoded within a predefined number of control blocks and transmitted to the receiver. The specified number of control blocks to carry this information may be determined based on the severity of the event, the speed of the network, and/or the anticipated time required for the network and its connected devices to prepare for the link-down condition.

As shown in block 310, the method may initiate the link-down event at the transmitter. In instances in which the encoding of the opcode within the control block persists for a predefined duration, the initiation of the link-down event at the transmitter may occur subsequent to a lapse of the predefined duration, allowing the receiver to process and respond to the information conveyed by the opcode. During this predefined interval, the receiver may have the opportunity to interpret the opcode and execute any necessary responsive actions. As such, the predefined duration may be determined to provide a sufficient window for the receiver to not only recognize the impending link-down but also to implement any requisite measures for maintaining device and/or network integrity. In instances in which the encoding of the opcode within the control block persists for a predefined number of subsequent control blocks, the initiation of the link-down event at the transmitter may occur subsequent to transmitting the predefined number of control blocks.

### Example Method for Receiving a Control Block Over a Communication Network

FIG. 4 illustrates an example method 400 for receiving a control block over a communication network, in accordance with an embodiment of the invention. As shown in block 402, the method may receive the control block via a physical layer of the communication network from a transmitter. As described herein, in an instance in which a transmitter detects an impending link-down event, the transmitter may initiate the process of notifying connected receivers (e.g., the device 104 as shown in FIG. 1) before initiating the link-down, allowing for a coordinated approach to network management. Specifically, information about the link-down event may be communicated by the transmitter by encoding an opcode identifying the link-down event within a control block and transmitting the control block via the physical layer of the communication network.

As shown in block 404, the method may extract, from the control block, an operational code (opcode) identifying an impending link-down event at the transmitter. The PCS may be used to receive and interpret the control block at the physical layer. Upon receipt of the encoded signals over the physical medium, such as copper wires, optical fibers, or wireless channels, the PCS at the receiver may decode these signals back into digital data. Each time a control block is received, the receiver, for example via the PCS, may examine a predefined location within the control block to check for the presence of an opcode. As described herein, the opcode may be used to identify a specific link-down event impending at the transmitter. In the case of an InfiniBand® communication network, for instance, the receiver's PCS may specifically examine Byte 7 of the TS1 control block. Similarly, in an Ethernet communication network, the receiver's PCS may check a specific location within the Faults control block for opcodes.

When an opcode is identified, the receiver may extract the opcode from its specific location within the control block. Once extracted, the opcode may then be decoded to identify the associated link-down event. To decode the opcode, the receiver may employ various techniques such as a look-up table (e.g., using a predefined lookup table where each opcode is mapped to a specific link-down event), algorithmic decoding (e.g., decoding the opcode using a predetermined algorithm), pattern matching (e.g., comparing the received opcode against a series of known patterns to identify the link-down event), contextual analysis (e.g., analyzing the opcode in the context of other network indicators), direct mapping in firmware or hardware, state machine logic, protocol-specific decoding, and/or the like.

Once extracted and decoded, the opcode may then be stored in a designated memory location, such as a database, for subsequent processing and analysis. The memory location may, for example, be a location in a memory of the device 104 or a memory accessible to the device 104. This storage is essential for maintaining a record of link-down events, facilitating troubleshooting, and enabling adaptive link-down event management based on historical data. In addition to storing the opcode, the receiver may also engage in a responsive communication with the transmitter. This may involve transmitting an acknowledgment back to the transmitter, signaling that the opcode has been successfully received, extracted, and decoded.

As shown in block 406, the method may retrieve, from a database, a responsive action corresponding to the link-down event based on the extracted opcode. Upon identifying the link-down event, the receiver may query a database that contains mapping of link-down events to responsive actions. This database may be a comprehensive repository that holds information on what actions should be taken for each type of link-down event. Based on the interpreted opcode, the receiver may retrieve the corresponding responsive action from the database. The responsive action may be predefined and tailored to effectively address the specific link-down event. The responsive actions can range from simple procedures such as temporarily pausing communication between the transmitter and the receiver, temporarily disabling a communication port, and/or the like, to more complex responses such as rerouting network traffic or initiating a hardware check.

As shown in block 408, the method may execute the responsive action. In the context of managing link-down events in an Infiniband® communication network, different opcodes within the TS1 Byte 7 of the control block may be mapped to specific responsive actions, as defined by their corresponding opcode descriptions. For instance, an opcode of 0×0, indicative of ‘Legacy mode’, may trigger the port to remain in its default state. This default state may be particularly relevant when the opcode does not provide any explicit reason for the link-down event, suggesting an impending but unspecified issue. In such cases, the receiver may adopt and subsequently execute a default responsive action, which may include maintaining the current state of the port without any specific alterations.

For link-down events that specify particular conditions, the receiver may execute more targeted responsive actions. For example, an opcode of 0×1, representing a ‘Local command to Sleep’, may result in the communication port transitioning to a SLEEP state. Similarly, opcodes 0×2 and 0×A, indicating ‘Local command to Disable’ and ‘Port is locked’, respectively, may trigger the port to enter the SLEEP state for the former and DISABLE state for the latter. In the case of a thermal event, represented by opcode 0×B, the receiver may place the communication port into a SLEEP state to mitigate the risk of overheating. A reset request, denoted by opcode 0×C, and a forced system shutdown, indicated by opcode 0×D, both may result in the port going into the SLEEP and DISABLE states, respectively. As such, in these cases, executing the responsive action may change a state of the receiver.

### Example Implementation of Link-Down Event Management Using Physical Layer Encoding

FIG. 5 illustrates an example implementation 500 of link-down event management using physical layer encoding, in accordance with an embodiment of the invention. As shown in FIG. 5, a GPU 502 may be operatively coupled to a smart NIC 504, a switch 506, a NIC 508, and another GPU 510. Each of these devices may be equipped with communication ports that facilitate their operational coupling. Specifically, the GPU 502 may include communication ports 502A; the smart NIC 504 may include communication ports 504A; the switch 506 may include communication ports 506A; the NIC 508 may include communication ports 508A; and the GPU 510 may include communication ports 510A. In this configuration, the various communication ports 502A of the GPU 502 are interconnected with the communication ports of the respective devices as shown in FIG. 5.

The handling of link-down events by the GPU 502 may vary depending on the nature and scope of the event. For instance, if the GPU 502 encounters a link-down event that impacts all its communication ports 502A, such as a thermal event that affects the entire GPU, the occurrence may be encoded into an opcode. This opcode may then be transmitted through all communication ports 502A of the GPU 502 that connect to other devices like the smart NIC 504, the switch 506, the NIC 508, and the GPU 510. This ensures that all connected devices are informed of the link-down event and can take appropriate responsive actions. Conversely, if the GPU 502 experiences a link-down event that only affects certain communication ports 502A, the response may be more targeted. An example of such a link-down event could be a localized hardware failure that impacts only a subset of the ports 502A. In this scenario, the link-down event may be encoded into an opcode and transmitted solely through the affected communication ports 502A. Only the devices operatively coupled to these specific ports would receive the opcode, allowing for a more focused and efficient network management response. This approach ensures that the rest of the network remains operational and unaffected by the isolated issue within the GPU 502.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A transmitter configured to transmit a control block over a communication network, the transmitter comprising:
a processor; and
a non-transitory storage device containing instructions that, when executed by the processor, cause the processor to:
detect an impending link-down event at the transmitter;
encode the link-down event within a control block;
transmit the control block via a physical layer of the communication network to a receiver; and
initiate the link-down event at the transmitter.

2. The transmitter of claim 1, wherein encoding the link-down event within the control block further comprises:
generating an operational code (opcode) identifying the link-down event, wherein the opcode, when decoded at the receiver, triggers a responsive action at the receiver corresponding to the link-down event.

3. The transmitter of claim 1, wherein the instructions, when executed, cause the processor to:
transmit the control block with the link-down event encoded therewithin to the receiver for a predefined duration after the detection of the impending link-down event at the transmitter; and
initiate the link-down event subsequent to a lapse of the predefined duration.

4. The transmitter of claim 1, wherein the instructions, when executed, cause the processor to:
transmit a predefined number of control blocks with the link-down event encoded therewithin to the receiver after the detection of the impending link-down event at the transmitter; and
initiate the link-down event subsequent to transmitting the predefined number of control blocks.

5. The transmitter of claim 1, wherein the communication network is a high-performance computing network, and wherein the control block is a training sequence 1 (TS1) control block.

6. The transmitter of claim 5, wherein encoding the link-down event within the control block further comprises encoding the link-down event within a designated byte of the TS1control block, wherein the designated byte is byte 7 of the TS1 control block.

7. The transmitter of claim 1, wherein the communication network is local area network (LAN), wherein the control block is associated with a binary block coding, and wherein the control block is a faults control block.

8. The transmitter of claim 1, wherein the link-down event comprises at least one of a thermal event, a device reset, a forced device shutdown, a local command to sleep, a local command to disable, or a locked port.

9. A receiver configured to receive a control block over a communication network, the receiver comprising:
a processor; and
a non-transitory storage device containing instructions that, when executed by the processor, cause the processor to:
receive the control block via a physical layer of the communication network from a transmitter;
extract, from the control block, an operational code (opcode) identifying an impending link-down event at the transmitter;
retrieve, from a database, a responsive action corresponding to the link-down event based on the extracted opcode; and
execute the responsive action.

10. The receiver of claim 9, wherein the instructions, when executed, cause the processor to:
transmit an acknowledgement of the impending link-down event to the transmitter in response to decoding the control block.

11. The receiver of claim 9, wherein the responsive action comprises at least temporarily pausing communication between the transmitter and the receiver.

12. The receiver of claim 9, wherein executing the responsive action corresponding to the link-down event changes a state of the receiver.

13. A method for transmitting a control block over a communication network, the method comprising:
detecting an impending link-down event at a transmitter;
encoding the link-down event within a control block control block;
transmitting the control block via a physical layer of the communication network to a receiver; and
initiating the link-down event at the transmitter.

14. The method of claim 13, wherein encoding the link-down event within the control block further comprises:
generating an operational code (opcode) identifying the link-down event, wherein the opcode, when decoded at the receiver, triggers a responsive action at the receiver corresponding to the link-down event.

15. The method of claim 13, further comprising:
transmitting the control block with the link-down event encoded therewithin to the receiver for a predefined duration after the detection of the impending link-down event at the transmitter; and
initiating the link-down event subsequent to a lapse of the predefined duration.

16. The method of claim 13, further comprising:
transmitting a predefined number of control blocks with the link-down event encoded therewithin to the receiver after the detection of the impending link-down event at the transmitter; and
initiating the link-down event subsequent to transmitting the predefined number of control blocks.

17. The method of claim 13, wherein the communication network is a high-performance computing network, and wherein the control block is a training sequence 1 (TS1) control block.

18. The method of claim 17, wherein encoding the link-down event within the control block further comprises encoding the link-down event within a designated byte of the TS1 control block, wherein the designated byte is byte 7 of the TS1 control block.

19. The method of claim 13, wherein the communication network is local area network (LAN), wherein the control block is associated with a binary block coding, and wherein the control block is a faults control block.

20. The method of claim 13, wherein the link-down event comprises at least one of a thermal event, a device reset, a forced device shutdown, a local command to sleep, a local command to disable, and/or a locked port.

21. A method for receiving a control block over a communication network, the method comprising:
receiving the control block via a physical layer of the communication network from a transmitter;
extracting, from the control block, an operational code (opcode) identifying an impending link-down event at the transmitter;
retrieving, from a database, a responsive action corresponding to the link-down event based on the extracted opcode; and
executing the responsive action.

22. The method of claim 21, further comprising:
transmitting an acknowledgement of the impending link-down event to the transmitter in response to extracting the opcode from the control block.

23. The method of claim 21, wherein the responsive action comprises at least temporarily pausing communication between the transmitter and the receiver.

24. The method of claim 21, wherein executing the responsive action corresponding to the link-down event changes a state of the receiver.
